(19) United States
(12) Patent Application Publication
(10) Pub. No.: US 2006/0098157 A1
(43) Pub. Date: May 11, 2006

(54) Captive push-on fastener with optional auxiliary frame mount

(76) Inventor: Jung I. Lee, Boca Raton, FL (US)

Correspondence Address: FLEIT, KAIN, GIBBONS, GUTMAN, BONGINI;& BIANCO P.L., ONE BOCA COMMERCE CENTER, 551 NORTHWEST 77TH STREET, SUITE 111, BOCA RATON, FL, 33487, US

(21) Appl. No.: 11/298,838

(22) Filed: Dec. 7, 2005

Related U.S. Application Data
(63) Continuation-in-part of application No. 10/515,957, filed on Nov. 24, 2004.
(60) Provisional application No. 60/405,214, filed on Aug. 22, 2002.

(51) Int. Cl. G02C 7/10

(52) U.S. Cl. 351/44

(57) ABSTRACT

A captive fastener for use with eyeglass assemblies is disclosed. The captive fastener comprises at least one fastening member which includes a first end and a second end. The first end comprising a hollow member with an inner cavity volume that is adapted for receiving an aciculate end of a first component of an eyeglass assembly. The hollow member has an outer volume that is defined to be inserted into a second component of the eyeglass assembly having an opening therein, for removeably fastening together the first component with the second component. The captive fastener also comprises a stopping collar formed around the outer volume of the hollow member between the first end of the fastening member and the second end of the fastening member for defining an insertable depth by the first end of the fastening member into the opening of the second member.

### CROSS-REFERENCE TO RELATED APPLICATIONS

This present U.S. patent application is a continuation-in-part of U.S. patent application Ser. No. 10/515,957, filed Nov. 24, 2004, which is based on PCT Application Serial No. PCT/US03/02971, filed Jan. 31, 203, which is based on U.S. patent application Ser. No. 10/346,595, filed Jan. 17, 2003, now U.S. Pat. No. 6,702,439 issued Mar. 9, 2004, which is based on U.S. Provisional Application No. 60/405,214, filed Aug. 22, 2002, which is based on PCT Application Serial No. PCT/US02/16478 filed May 24, 2002, which is based on U.S. Provisional Application No. 60/312,124, filed Aug. 14, 2001. All of the above-referenced patent applications are hereby incorporated by reference in their entirety.

### FIELD OF THE INVENTION

The present invention broadly relates to eyeglasses, and more particularly relates to a fastener for fastening together components of an eyeglass assembly.

### BACKGROUND OF THE INVENTION

To alleviate the need to carry multiple pairs of eyeglasses, various types of “clip-on” auxiliary spectacles have been introduced. Primarily, this allows auxiliary spectacles to be attached to a pair of primary spectacles. However, modern eyeglasses not only need to be functional, but also need to be fashionable. Many different configurations for the frames of the primary and the auxiliary spectacles exist. For example, the variety frame types include full-frame, frameless, quarter-rimmed, half-rimmed, or the like.

One problem that exists is the way components of an eyeglass assembly are fastened to lenses. When an eyeglass assembly is frameless, holes need to be drilled in the lens for fastening a temple piece or nose bridge to the lens. Many times screws are used, which can cause stress cracks in the lens if over tightened. Also, the screws need to be capped to protect a user from sharp ends of the screw.

Additionally, current fasteners require a prying device to remove the fastener from the components of the eyeglass assembly. The prying device can damage the components, especially the lens when pressure is applied to pry the fastener off. The fastening device cannot be displaced far enough from the eyeglass assembly so that the fastening device can be safely removed. Therefore, a need exists for a fastener that can be easily removed without damaging the components of the eyeglass assembly.

Another problem is that eyeglass assemblies usually do not come in different sizes for a more customized fit. Individuals who like a design of one pair of primary or auxiliary spectacles may not be able to use them because they do not fit their faces correctly. Additionally, a user may become tired of wearing the same primary or auxiliary spectacles and want to change the frames, ear stem, temple piece, or the like. However, this may be cumbersome and expensive because the prior art eyeglass assemblies are not modular or have fasteners that are not created for continuous removal. Therefore, a need exists for a fastener that allows eyeglass assemblies to be modular with easily interchangeable components of various sizes and styles.

### SUMMARY OF THE INVENTION

Briefly, in accordance with the present invention, disclosed is a captive fastener for use with eyeglass assemblies. The captive fastener comprises at least one fastening member which includes a first end and a second end. The first end comprising a hollow member with an inner cavity volume that is adapted for receiving an aciculate end of a first component of an eyeglass assembly. The hollow member has an outer volume that is defined to be inserted into a second component of the eyeglass assembly having an opening therein, for removeably fastening together the first component with the second component. The captive fastener also comprises a stopping collar formed around the outer volume of the hollow member between the first end of the fastening member and the second end of the fastening member for defining an insertable depth by the first end of the fastening member into the opening of the second member.

In another embodiment of the present invention a set of auxiliary spectacles for use in conjunction with primary spectacles are disclosed. The auxiliary spectacles comprise at least one receiving component having at least one opening therein and at least one insertable component including at least one aciculate end. The auxiliary spectacles further include at least one captive fastener. The captive fastener comprises at least one fastening member that includes a first end and a second end. The first end comprises a hollow member with an inner cavity volume that is adapted for receiving the aciculate end of the insertable component. The hollow member has an outer volume that is defined to be inserted into the opening of the receiving component, for removeably fastening together the receiving component with the insertable component. The captive fastener includes a stopping collar formed around the outer volume of the hollow member between the first end of the fastening member and the second end of the fastening member for defining an insertable depth by the first end of the fastening member into the opening of the receiving component.

The features of the present invention are advantageous because the captive fastener allows the eyeglass assembly to be customizable. For example, a user can select from a variety of components made from different materials, different colors, different sizes, and different styles and then have these components put together to create the eyeglass assembly. Individuals who may require larger or smaller components can easily interchange components for a customized fit.

Additionally, the captive fastener can be removed without damaging the lens or other components of the eyeglass assembly. Tools that may cause damage to the eyeglass assembly are no longer needed to remove a fastener. Also, screws to join eyeglass components together and that cause cracks are no loner required.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention will be apparent from the following detailed description taken in conjunction with the accompanying drawings in which:

FIG. 1 is an exploded top view of a first embodiment of a set of primary spectacles;

FIG. 2 is an exploded side view of a second embodiment of the ear stem in FIG. 1;

FIG. 3 is a side view of a component of an eyeglass assembly with aciculate ends;

FIG. 4 is a right perspective view of a first embodiment of a captive fastener;

FIG. 5 is a right perspective view of a second embodiment of the captive fastener of FIG. 4;

FIG. 6 is a top planar view of the present invention with the captive fastener of FIG. 4 partially inserted into a component of an eyeglass assembly;

FIG. 7 is a top planar view of the present invention after the captive fastener of FIG. 4 is completely inserted into a component of an eyeglass assembly

FIG. 8 is an exploded top view of a third embodiment of the set of primary spectacles in FIG. 1

FIG. 9 is a top planar view of a third embodiment of the captive fastener of FIG. 4;

FIG. 10 is a left perspective view of a fourth embodiment of the captive fastener of FIG. 4;

FIG. 11 is a front view of a first embodiment of a lens assembly;

FIG. 12 is a front view of a second embodiment of a lens assembly;

FIG. 13 is a front view of a third embodiment of a lens assembly;

FIG. 14 is a front view of a fourth embodiment of a lens assembly;

FIG. 15 is a top view of the primary spectacles shown FIG. 1 in an assembled form;

FIG. 16 is a top view of a first embodiment of a set of auxiliary spectacles;

FIG. 17 is a front view of the set of auxiliary spectacles of FIG. 16.

FIG. 18 is a top view of a third embodiment of the primary spectacles of FIG. 1;

FIG. 19 is a top view of a second embodiment of the set of auxiliary spectacles of FIG. 16;

FIG. 20 is a front view of the set of auxiliary spectacles of FIG. 19;

FIG. 21 is a side view, illustrating a configuration wherein the set of primary spectacles of FIG. 15 and the set of auxiliary spectacles of FIG. 16 are decoupled with each other;

FIG. 22 is a side view, illustrating a state wherein the set of primary spectacles of FIG. 15 and the set of auxiliary spectacles of FIG. 16 are coupled with each other;

FIG. 23 is a side view, illustrating a state wherein the set of primary spectacles of FIG. 15 and the set of auxiliary spectacles of FIG. 16 are coupled with each other and in a “flip-up” position;

FIG. 24 is a front view of a first embodiment of the magnetic members of the present invention;

FIG. 25 is a front view of a second embodiment of the magnetic members of the present invention;

FIG. 26 is a front view of a third embodiment of the magnetic members of the present invention;

FIG. 27 is a top view of a fourth embodiment of the set of primary spectacles of FIG. 1;

FIG. 28 is a top view of a third embodiment of the set of auxiliary spectacles of FIG. 16; and

FIG. 29 is a front view of the set of auxiliary spectacles of FIG. 28.

FIG. 30 is a front view of a fifth embodiment of of the captive fastener of FIG. 4;

FIG. 31 is a top planar view of the present invention with the captive fastener of FIG. 30 inserted into a component of an eyeglass assembly; and

FIG. 32 is a top planar view of the present invention with the captive fastener of FIG. 30 partially inserted into a component of an eyeglass assembly, according to an alternative embodiment of the present invention.

### DESCRIPTION OF THE PREFERRED EMBODIMENTS

It should be understood that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements may be in the plural and vice versa with no loss of generality. In the drawings, like numerals refer to like parts through several views.

The present invention, according to an exemplary embodiment, overcomes drawbacks and problems with the prior art by presenting a safer, more secure fastener for removeably fastening together components of an eyeglass assembly with optional mounts for coupling auxiliary spectacles to primary spectacles. An exemplary embodiment and several subsequent embodiments displaying slight variations of the present invention are now described.

Primary Spectacles

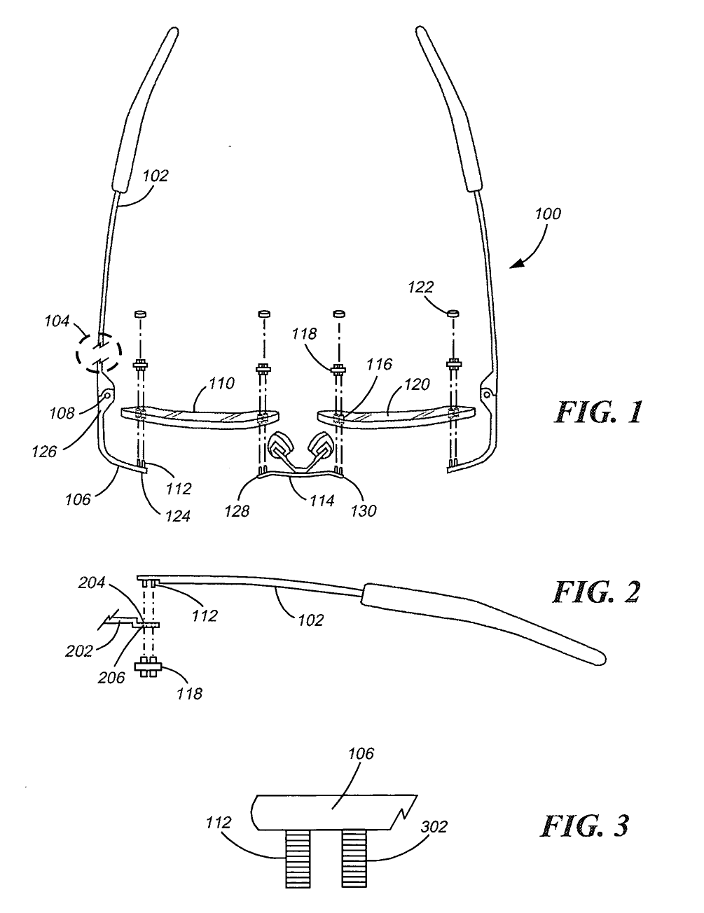

Referring to FIG. 1 there is shown an exploded top view of a set of primary spectacles 100 according to a first embodiment of the present invention. The spectacles include a pair of ear stems 102 and a pair of temple pieces 106. Each temple piece 106 includes a first end 124 with an aciculate end that connects the temple piece 106 to a primary lens 110. The embodiment in FIG. 1 shows a pair of primary lenses 110; however, in another embodiment, a single lens is used in accordance with the present invention. A hinge 108 connects the ear stem 102 to a second end 126 of the temple piece 106. The ear stem 102, for example, is a continuous piece or modular, as shown in FIG. 2. The first end 124 of the temple piece 106 includes at least one aciculated member 112 that is inserted into a component of the primary spectacles 100. For example, FIG. 1 shows the primary lens 110 including two openings 116 disposed on the outer edges of the primary lens 110. However, the openings 116, in one embodiment, are disposed anywhere on the primary lens 110. Each aciculated member 112, for example, includes ridges, grooves, or threads 302, as shown in FIG. 3. The primary spectacles 100 also include a primary nose bridge 114 comprising a first end 128 and a second end 130. Each end of the primary nose bridge 114 includes at least one aciculated member for inserting into a corresponding opening 116 on a component of the primary spectacles. For example, FIG. 1 shows the primary lens 110 including the corresponding openings 116 for the aciculated members 112 of the nose bridge 114. However, in one embodiment, the primary spectacles 100 include a frame (not shown) comprising the corresponding openings 116.

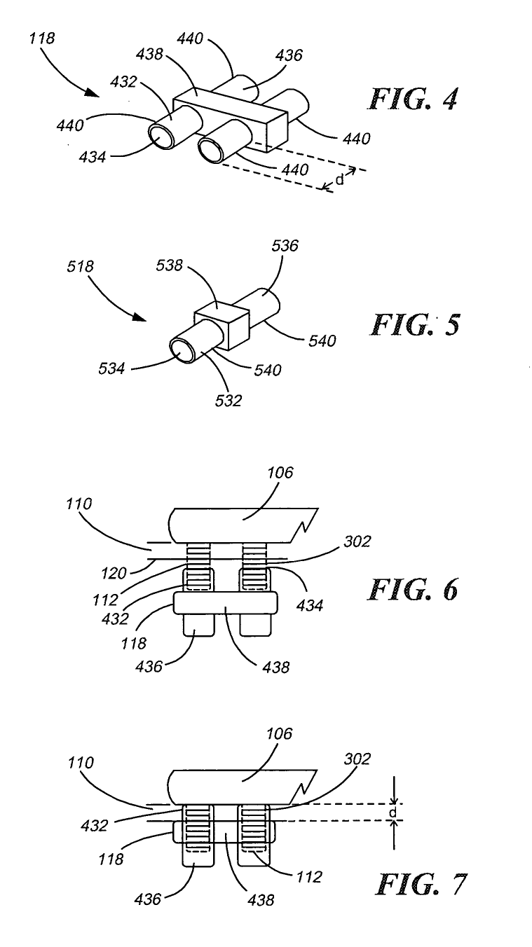

The primary spectacles 100 also include at least one captive fastener 118 for removeably fastening the components of the primary spectacles 100. The captive fastener 118 is inserted into the opening 116, for example, from the inside surface 120 of the primary lens 110 and captively engages the aciculated member 112 of the corresponding component, e.g. the temple piece 106 or primary nose bridge 114. The ridges 302 (FIG. 3) of the aciculated member 112 help ensure that the aciculated member 112 and the captive fastener 118 securely engage one another. The captive fastener 118 will be described in greater detail with respect to FIGS. 4-7. An optional magnetic member 122 can be disposed on the captive fastener 122 for coupling a set of auxiliary spectacles (not shown) to the set of primary spectacles 100.

Example of a Modular Component for the Primary Spectacles

FIG. 2 shows an exploded side view of a second embodiment of the ear stem 102 in FIG. 1. FIG. 2 shows in greater detail the section in FIG. 1 denoted by the dashed circle 104. As discussed above, the ear stem 102 can be modular or one continuous piece. For example, a second ear stem piece 202 is attached to the temple piece 106 by a hinge 108 and includes a first portion 204 having at least one opening 206. When the aciculated members 112 of the first ear stem piece 102 are inserted into the openings 206 of the second ear stem piece 202, a complete ear stem piece is formed. The first and second ear stem pieces 102, 202 are removeably fastened together by a captive fastener 118. Although FIG. 2 shows the first ear stem piece being removeably fastened to the second ear stem piece 202 from a bottom/top orientation, the two ear stem pieces 102, 202 can also be removeably fastened from any orientation, for example, an inside/outside or outside/inside orientation. Additionally, more than two pieces can be used to create an ear stem. The temple piece 106 can also be modular and the hinge 108 can be included on the temple piece 106 or an ear stem piece 102, 202. The use of a modular ear piece construction enables a variety of shapes, colors, styles, and sizes to be quickly assembled. This avoids the need of ordering and stocking every combination of ear piece assembly.

Captive Fastener

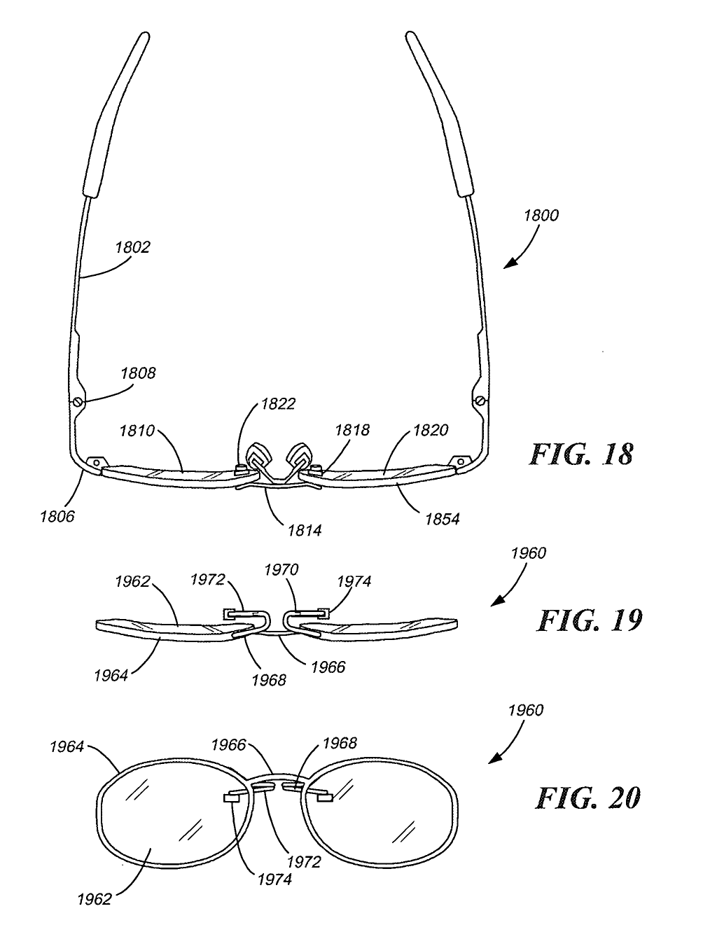

FIG. 4 and FIG. 5 show a right perspective view of two exemplary embodiments of the captive fastener 118, 518. The captive fasteners 118, 518 of FIG. 4 and FIG. 5 are similar except for the number of fastening members 440, 540. For example, the captive fastener 118 of FIG. 4 includes two fastening members 440 and the captive fastener 518 of FIG. 5 includes one captive fastener 518. However, the captive fastener 118, 518 is not limited to having only one or two fastening members 440, 540. The following discussion regarding the captive fastener 118 is applicable to both embodiments of the captive fastener 118, 518 and to embodiments including more than three captive fasteners (not shown). The captive fastener 118 includes a first end 432 and a second 436. The first end 432 comprises a hollow member 434 with an inner cavity volume that is adapted for receiving an aciculate end 112 of a first component of an eyeglass assembly. A first component, for example, can be any one of a nose bridge 114, a temple piece, 106, an extension arm 1664 (FIG. 16), and an ear stem 102. An eyeglass assembly, for example, is either a set of primary spectacles 100, or a set of auxiliary spectacles 1660. The hollow member 434 also includes an outer volume defined to be inserted into a second component of the eyeglass assembly. The second component includes at least one opening 116 and can be any one of a lens 110, a temple piece 106, an ear stem 102, and a frame 1854 (FIG. 18).

The fastening member 440 also includes stopping collar 438 formed around the outer volume of the hollow member 434 between the first end 432 and second end 436 of the fastening member 440. The stopping collar 438 defines an insertable depth d by which the first end of the fastening member 432 can be inserted into the opening 116 of the second member. The stopping collar 438 prevents the hollow member 434 from passing completely through the opening of the second component. Additionally, the captive fastener 118 can be formed from any organic or an inorganic material including plastic, metal, carbon fiber, wood, and any combination thereof. Also, the captive fastener 118 can be colored or colorless to match a desired style or fashion.

The Captive Fastener Before and After Removeably Fastening Two Components of an Eyeglass Assembly

FIG. 6 and FIG. 7 respectively show a top planar view of the captive fastener 118 during and after being inserted into a second component of an eyeglass assembly for removeably fastening the first component and second component together. The aciculate end 112 of the first component of the eyeglass assembly, for example, the temple piece 106, is inserted into the corresponding openings 116 of the second component of the eyeglass assembly, in this example, the second component is a lens 110. FIG. 6 and FIG. 7 show the aciculate ends 112 passing completely through the lens 110; however, in an alternative embodiment of the present invention, the aciculate ends 112 only pass partially through the second component of the eyeglass assembly. The captive fastener 118 is disposed on the aciculate ends 112 by applying a horizontal force to the captive fastener 118 in a parallel direction with the aciculate ends 112. The horizontal force can be applied, for example, by a tool or by pushing the captive fastener 118 onto the aciculate ends 112. As the horizontal force is applied, the first end 432 of the fastening member 440 captively engages the aciculate end 112 and becomes inserted into the opening 116 of the lens 110. When the first end 432 reaches its maximum insertable depth d which in this embodiment is the thickness of the lens 110, the stopping collar abuts an adjacent surface 120 the lens 110. This results in the first component and the second component are removeably fastened together.

The ridges 302 disposed on the aciculate ends 112 of the first end 432 of the fastening member 440 provide an outward radial force against the hollow member 434 so that the first component and second component are securely fastened together. One advantage of the present invention is that even though the captive fastener 118 securely fastens the first and second components of the eyeglass assembly together, the captive fastener 118 can be removed without damaging any of the components. Prying is no longer needed to remove the fastener and there are no screws to be removed as in the prior art. For example, in the prior art a prying device such as a screw driver is used to pop a fastener off of the fastened component. The prying device can easily scratch or damage the lens when an excessive amount of force is applied. Also, the screws used in the prior art to fasten components together can cause stress cracks in the lens or components when the screws are tightened. The screws also need to be capped to protect the user from the edges of the screw. No cap is required using the captive fastener 118 of the present invention.

Additionally, because the components are easily removable, the eyeglass assembly fully customizable. For example, the present invention allows a user to design the eyeglass assembly by selecting the different configuration of components such as the frames, lenses, ear stems, nose bridges, and the like. Also, the modularity of the present invention allows the eyeglass assembly to be easily sizeable so that the eyeglass assembly fits the user better.

Second Embodiment of the Primary Spectacles

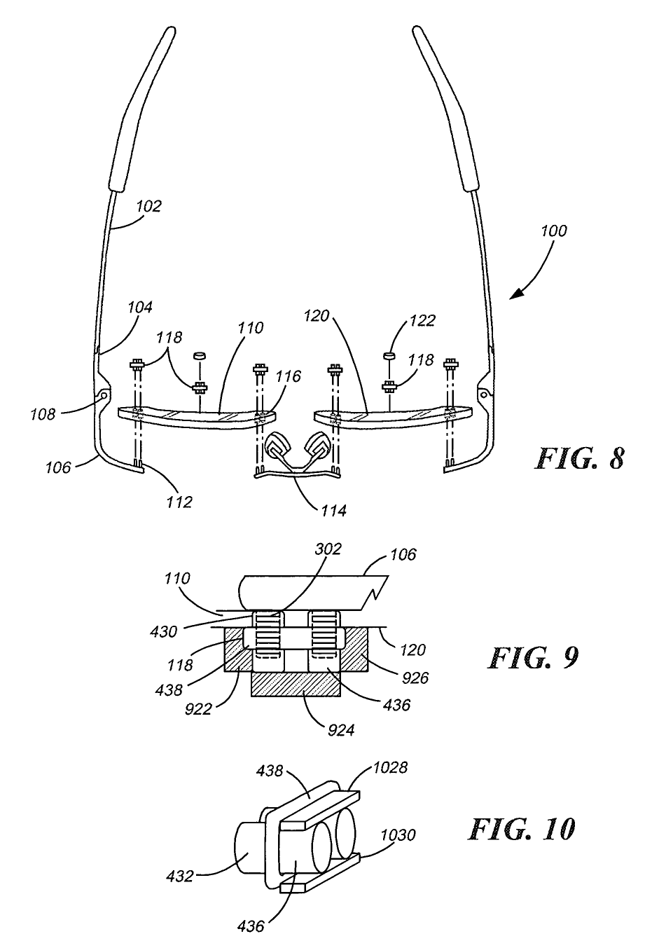

FIG. 8 shows an exploded top view of a second embodiment of the primary spectacles 100 in FIG. 1. More specifically, FIG. 8 shows the optional placement positions of the captive fastener. For example, the captive fastener 118 with the magnetic member 122 disposed thereon may be placed on an outer portion and/or an inner portion of the lens 110. Alternatively, the captive fastener 118 with the magnetic member 122 disposed thereon may optionally be placed on an upper portion and a lower portion of the lens 110. The captive fastener 118 and the magnetic member 122 are not restricted to being disposed on the lens 110, for example, the captive fastener 118 and the magnetic member 122 in one embodiment, are disposed on a frame (not shown), an ear stem 102, or a temple piece 106. Also, the captive fastener 118, in one embodiment, is disposed on a component of the eyeglass assembly by itself, in other words, without a magnetic member 122.

Optional Areas for Placement of the Magnetic Members

FIG. 9 and FIG. 10 show a top planar view and a left perspective view respectively of the captive fastener 118 with optional areas of placement for the magnetic member 122. The magnetic member 122, for example, is disposed on a first portion of the second component that is opposite of a second portion of the second component into which the aciculate end 112 of the first component was inserted int. For example, FIG. 9 shows a first component, the temple piece 106, being inserted into an outer surface of the lens (the second component) which is opposite of the side that the magnetic members 922, 924, 926 are disposed on.

Additionally the magnetic member 122 may be disposed anywhere on the second end 436 of the captive fastener 118. For example, FIG. 9 shows the optional placement of the magnetic member 922 on a left outer portion of the second end 436 of the captive fastener 118. Alternatively, a magnetic member 924, 926, in one embodiment is disposed on an outer front portion and/or a right outer of the second end 436 of the captive fastener respectively. The inner left and right walls of the second ends 436 and the front middle wall of the stopping collar 438, in one embodiment, optionally include a magnetic member 122 (not shown) disposed thereon. The magnetic members 1028, 1030, in one embodiment, is disposed on a top portion and a bottom portion of the second ends 436 of the captive fastener 118, as shown in FIG. 10. In another embodiment, the magnetic members 922, 924, 926 1028, and 1030 instead of being made from magnetic material are made from material to which a magnet may attach.

Optional Embodiments of a Lens Assembly

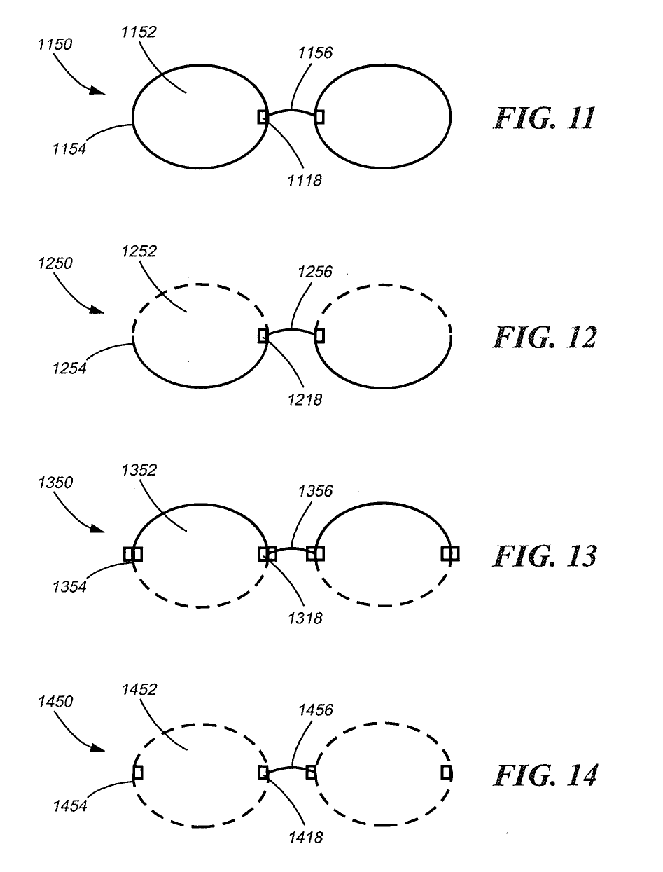

FIGS. 11-14 show a frontal view of alternative embodiments of an eyeglass assembly. As discussed above with respect to FIG. 4 and FIG. 5, the eyeglass assembly, for example, can be a primary set of spectacles 100 or an auxiliary set of spectacles 1660 (FIG. 16). FIG. 11 shows an eyeglass assembly 1150 including a pair of lenses 1152, a full frame 1154, a nose bridge 1156 and a pair of captive fasteners 1118 for removeably fastening the nose bridge 1156 and the lenses together. Alternatively, the nose bridge 1156 can be a molded to the lens frame 1154 or the captive fasteners 1118 can be used to removeably fasten the nose bridge 1156 and the frame 1154 together.

FIG. 12 shows an eyeglass assembly 1250 including a pair of lenses 1252, a half-rimmed frame 1254 for the lower half of the eyeglass assembly, a nose bridge 1256, and a pair of captive fasteners 1218 for removeably fastening the nose bridge 1256 and the lenses together. Alternatively, the nose bridge 1256 can be a molded to the lens frame 1254 or the captive fasteners 1218 can be used to removeably fasten the nose bridge 1256 and the frame 1254 together.

FIG. 13 shows an eyeglass assembly 1350 including a pair of lenses 1352, a half-rimmed frame 1354 for the upper half of the eyeglass assembly, a nose bridge 1356, and a pair of captive fasteners 1318 for removeably fastening the nose bridge 1356 and the lenses together. Alternatively, the nose bridge 1356 can be a molded to the lens frame 1354 or the captive fasteners 1318 can be used to removeably fasten the nose bridge 1356 and the frame 1354 together.

FIG. 14 shows an eyeglass assembly 1450 including a pair of lenses 1452, a nose bridge 1456, and a pair of captive fasteners 1418 for removeably fastening the nose bridge 1456 and the lenses 1452 together. The eyeglass assembly in FIG. 14 is frameless, as denoted by the dashed lines 1454.

It should be appreciated that the present invention is not limited to the embodiments illustrated in FIGS. 11-14. For example, the eyeglass assembly, in one embodiment, also includes frames going across a top portion of the lenses only, quarter frames, three-quarter frames, partial frames, or the like. Also, the captive fasteners 1118, 1218, 1318, 1418 in alternative embodiments are located on the inside and/or outside portion of the eyeglass assemblies where the nose bridge 1218 is attached, as shown in FIG. 12, or where temple pieces are attached. In additional embodiments of the present invention, the captive fasteners 1118, 1218, 1318, 1418 are situated at any point around the outside and/or inside of the eyeglass assemblies 1150, 1250, 1350, 1450.

Assembled Primary Spectacles

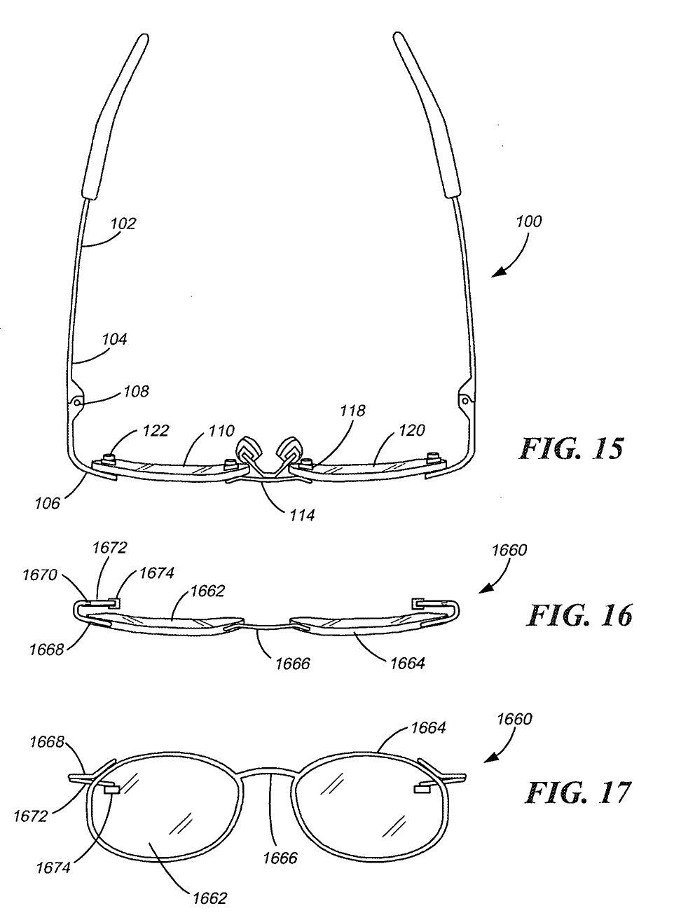

FIG. 15 shows a top view of the primary spectacles 100 in an assembled form. The ear stem 102 is removeably fastened to the second ear stem component 104 forming a continuous ear stem piece. The temple piece 106 and the primary nose bridge 114 are removeably fastened to the lens 110 by the captive fasteners 118. The magnetic members 122 are disposed on the on the captive fasteners 118 for coupling the primary spectacles 100 to a set of auxiliary spectacles 1660 (FIG. 16).

Auxiliary Spectacles

FIG. 16 and FIG. 17 show a top view and a frontal view respectively of a first embodiment of a set of auxiliary spectacles 1660. The auxiliary spectacles 1660 include at least one lens 1662 and a lens frame 1664. Alternatively, as discussed above with respect to FIGS. 11-14, the auxiliary spectacles 1660, for example, may be frameless, half-rimmed, or the like. The auxiliary spectacles 1660 also include an auxiliary nose bridge 1666 attached to the frame 1664 and an outward extension arm 1668. The outward extension arm 1668 includes a hinge 1670 that connects an inward extension arm 1672. The inward extension arm 1672 includes a magnetic member 1674 disposed on an end for magnetically coupling the auxiliary spectacles 1660 to the set of primary spectacles 100. Further, the auxiliary spectacles include any type of lenses such as sunglass, prescription, magnifying, reading, photo-chromatic, and clear safety lenses.

Third Embodiment of the Primary Spectacles

FIG. 18 shows a top view of a fourth embodiment of the set of primary spectacles 1800 in an assembled form ready for being coupled with a set of auxiliary spectacles 1960 (FIG. 19). The primary spectacles 1800 include a pair of ear stems 1802 connected to a pair of temple pieces 1806 by a hinge 1808. Each temple piece 1806 is, for example, optionally molded to a lens frame 1854. The primary spectacles 1800 also includes a pair of lenses 1810 and a primary nose bridge 1814 that is removeably fastened to the lenses 1810 by a pair of captive fasteners 1812. Each captive fastener 1818 has a magnetic member 1822 disposed thereon for magnetically coupling the primary spectacles 1818 with a set of auxiliary spectacles 1960 (FIG. 19). Additionally, the ear stem 1802 or the temple piece 1806 can be, for example, modular as discussed above with respect to FIG. 1 and FIG. 2.

Second Embodiment of the Auxiliary Spectacles

FIG. 19 and FIG. 20 show a top view and a frontal view respectively of a second embodiment of a set of auxiliary spectacles 1960. The auxiliary spectacles 1960 include at least one lens 1962 and a lens frame 1964. Alternatively, as discussed above with respect to FIGS. 11-14, the auxiliary spectacles 1960, for example, may be frameless, half-rimmed, or the like. The auxiliary spectacles 1960 also include an auxiliary nose bridge 1966 attached to the frame 1964 and an inward extension arm 1968 disposed on an upper inner portion of the lens frame 1964 above the outer ends of the auxiliary nose bridge 1966. The inward extension arm 1968 includes a hinge 1970 that connects an outward extension arm 1972. The outward extension arm 1972 includes a magnetic member 1974 disposed on an outer end of the outward extension arm 1972 for magnetically coupling the auxiliary spectacles 1960 to the primary spectacles 1800 (FIG. 18) by magnetically coupling to the magnetic members 1822 disposed on the captive fasteners 1822 of the primary spectacles 1800.

As stated above with respect to FIG. 4. and FIG. 5, auxiliary spectacles according to the present invention, in one embodiment, includes components removeably fastened together by a captive fastener. The auxiliary spectacles 1660, 1960 are not limited to having molded components. Similar to the above embodiments of the primary spectacles 100, 1500, 1800, the auxiliary spectacles may also include modular components that are removable fastened by captive fasteners. In an exemplary embodiment of the present invention (not shown), the auxiliary spectacles 1660, 1960 include at least one receiving component having at lest one opening therein. For example, a frame 1664 and/or a lens 1662 may each have at least one opening similar to the opening 116 of the primary spectacles 100 discussed above with respect to FIG. 1.

Additionally, the auxiliary spectacles 1660, 1960, in one embodiment, include at least one insertable component comprising at least one aciculate end. For example, the nose bridge 1966, the extension arms 1968, and/or the frame 1964 may include at least one aciculate end similar to the aciculate end 112 of the primary spectacles 100. The auxiliary spectacles 1660, 1960 also include at least one captive fastener similar to the captive fastener 118 of the primary spectacles 100 for removeably coupling the at least one receiving component and insertable component of the auxiliary spectacles 1660, 1960 together.

Decoupled and Coupled State of the Primary and Auxiliary Spectacles

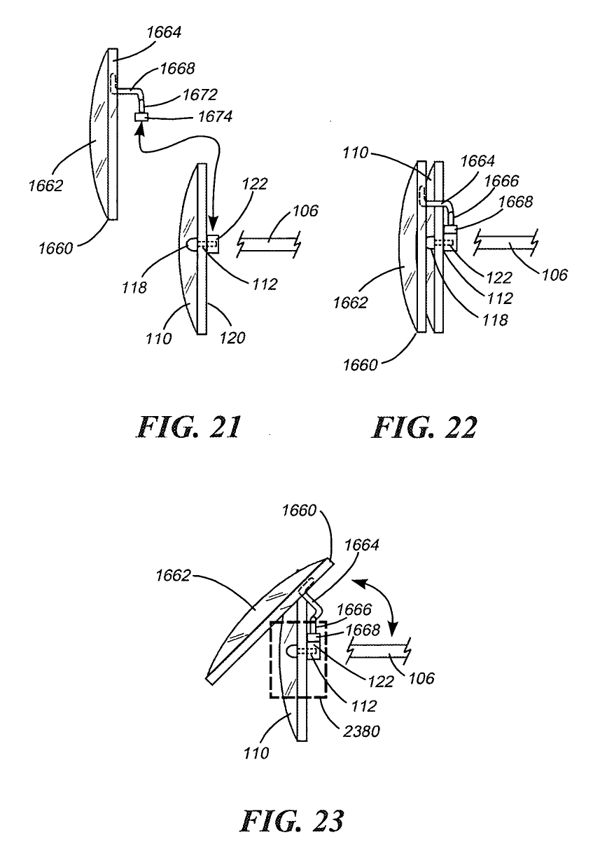

FIGS. 21-23 show a side view illustrating how the auxiliary spectacles 1660 can be coupled to the primary spectacle 100. The magnetic member 1674 of the inward extension arm 1672 rests on and/or is insertable into the magnetic member 122 of the captive fastener 118 of the primary spectacles 100. The magnetic members 1674, 122 securely couple the auxiliary spectacles 1660 and the primary spectacles 100 together. When coupled together with the primary spectacles 100, the auxiliary spectacles can be manipulated in a number of different positions. For example FIG. 22 shows a first position in which the auxiliary spectacles 1660 are in a vision path of the user. Alternatively, FIG. 23 shows a second position in which the auxiliary spectacles 1660 are at least partially outside of the vision path of the user.

A user, for example, may want to have the auxiliary spectacles 1660 in the vision path because the lenses 1662 of the auxiliary spectacles are polarized, shaded, magnified, bi-focal or the like. When the benefit of the auxiliary spectacles 1660 are no longer needed, the user can flip the auxiliary spectacles 1660 upwards and out of the vision path. The bond between the magnetic members 1674, 122 is strong enough to securely couple the auxiliary spectacles 1660 to the primary spectacles 100 when manipulating the position of the auxiliary spectacles 1660 about the primary spectacles 100, but allows the auxiliary spectacles 1660 to be easily removed by the user.

Exemplary Embodiments of the Magnetic Members

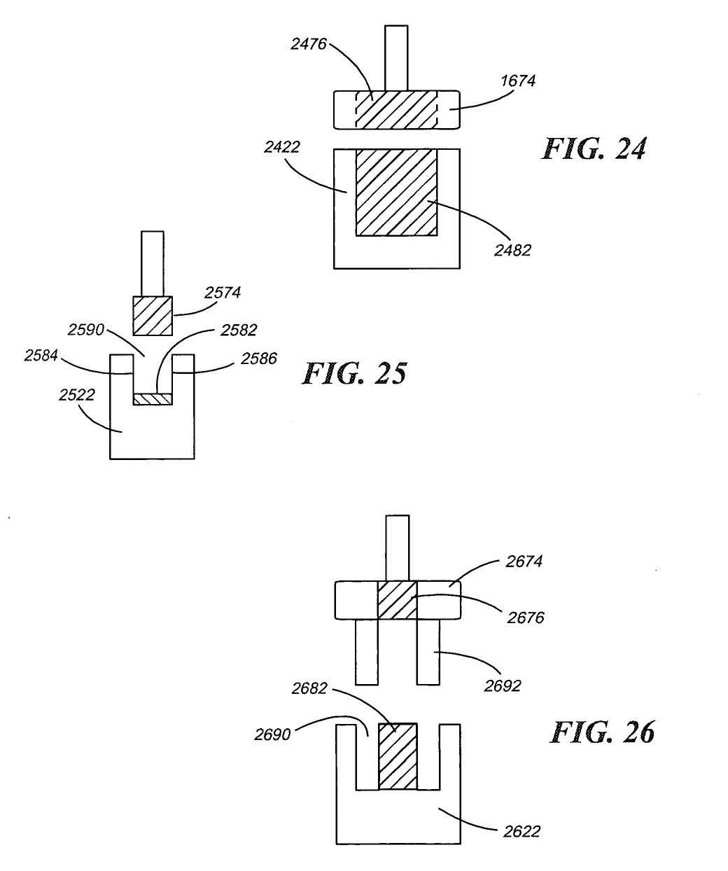

FIGS. 24-26 illustrate a more detailed front view of the magnetic members 122, 1674 of the present invention as denoted by the dashed lines 2380 in FIG. 23. FIG. 24 shows the auxiliary magnetic member 1674 of the auxiliary spectacles 1660 (not shown) including a magnetic portion 2476 that corresponds to a magnetic portion 2482 of the primary magnetic member 2422 of the primary spectacles 100. FIG. 25 illustrates the auxiliary magnetic member 2574 of the auxiliary spectacles 1660 being magnetic and corresponding to a magnetic cavity 2590 of the primary magnetic member 2522 of the primary spectacles 100 that includes at least a magnetic portion 2582. When the auxiliary magnetic member 2574 is inserted in to the magnetic cavity 2582 of the primary magnetic member 2522, the walls 2584, 2586 of the magnetic cavity 2590 are adjacent to the auxiliary magnetic member 2574, thereby preventing rotational and axial forces from prematurely decoupling the auxiliary spectacles 1660 from the primary spectacles 100.

FIG. 26 shows the auxiliary magnetic member 2674 including a magnetic portion 2676 that corresponds to a magnetic portion 2682 of the primary magnetic member 2622. The auxiliary magnetic member 2674 also includes at least one vertical member 2692 for inserting into a corresponding cavity 2690 of the primary magnetic member 2622. When the vertical member 2692 is inserted into the corresponding cavity 2690 of the primary magnetic member 2622, the magnetic portion 2676 of the auxiliary magnetic member 2674 rests on an upper portion of the magnetic portion of the primary magnetic member 2622. The outer walls of the vertical members 2692 rest adjacent to the outer vertical walls of the cavity 2690 and the magnetic portion 2682 and the bottom portion of the vertical member 2692 rests adjacent to the bottom portion of the cavity 2690, thereby preventing rotational and axial forces from prematurely decoupling the auxiliary spectacles 1660 from the primary spectacles 100.

The configuration of the auxiliary and primary magnetic members 1674, 2422, 2574, 2522, 2674, 2622 of the present invention overcomes the problem in the prior art of securely coupling the auxiliary and primary spectacles by using magnets. When inserted into their corresponding cavities 2582, 2690. The magnetic members 2574 and vertical members 2692 prevent dynamic loads and jarring movements that occur during, for example, during exercise.

Fourth Embodiment of the Primary Spectacles

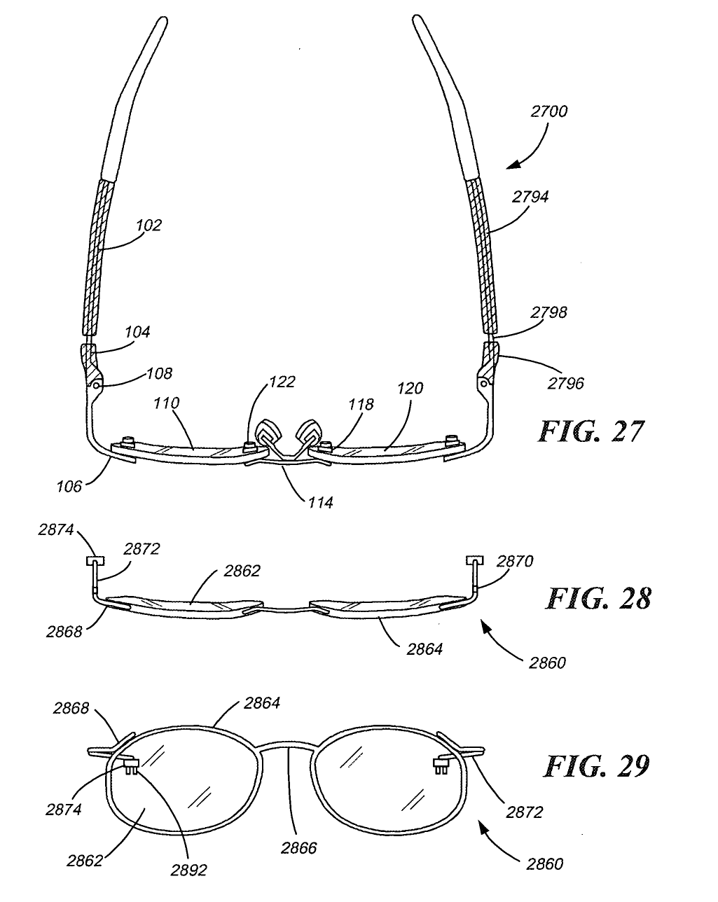

FIG. 27 shows a top view of a fourth embodiment of the primary spectacles 100 in FIG. 1. The primary spectacles 2700 in FIG. 27 are similar to the primary spectacles 100, 1500 discussed with respect to FIG. 1 and FIG. 15 except that a pair of sleeves 2794, 2796 has been added to the ear stem 102. The sleeves 2794, 2796 are disposed on the ear stem 102 so that a gap 2798 corresponding to a coupling member 2874 (FIG. 28) of a set of auxiliary spectacles 2860 is formed. The sleeve, for example, may be metallic, magnetic, plastic or the like. The gap exposes a portion of the ear stem for receiving the coupling member 2874 (FIG. 28) of the auxiliary spectacles 2860. In another embodiment, a sleeve or sleeves are disposed on the temple piece 106 so that the gap corresponding to a coupling member 2874 (FIG. 28) of a set of auxiliary spectacles 2860 is formed.

Third Embodiment of the Auxiliary Spectacles

FIG. 28 and FIG. 29 show a top view and a frontal view respectively of a set of auxiliary spectacles 2860 for coupling with the primary spectacles 2700 in FIG. 7. The auxiliary spectacles 2860 are similar to the auxiliary spectacles 1660, 1960 discussed with respect to FIG. 16 and FIG. 19. However, the auxiliary spectacles 2860 of FIG. 28 have a backwardly extending extension arm 2872 that is connected to an outwardly extending extension arm 2868. The backwardly extending extension arm 2872 includes a forked member 2874 comprising at least two vertical forked appendages 2892. The forked member 2874 couples the auxiliary spectacles 2860 to the primary spectacles 2700 by coupling onto the exposed portion 2798 of the ear stem 102. When placed onto the exposed portion 2798 of the ear stem 102, vertical appendages 2892 of the forked member 2874 are situated adjacent against the inner wall of the sleeves 2794, 2796 disposed on the ear stem 102; thereby preventing rotation and axial forces from decoupling the auxiliary spectacles 2860 form the primary spectacles 2700. In another embodiment, the forked member, for example, may is magnetic.

Alternative Embodiment of the Captive Fastener

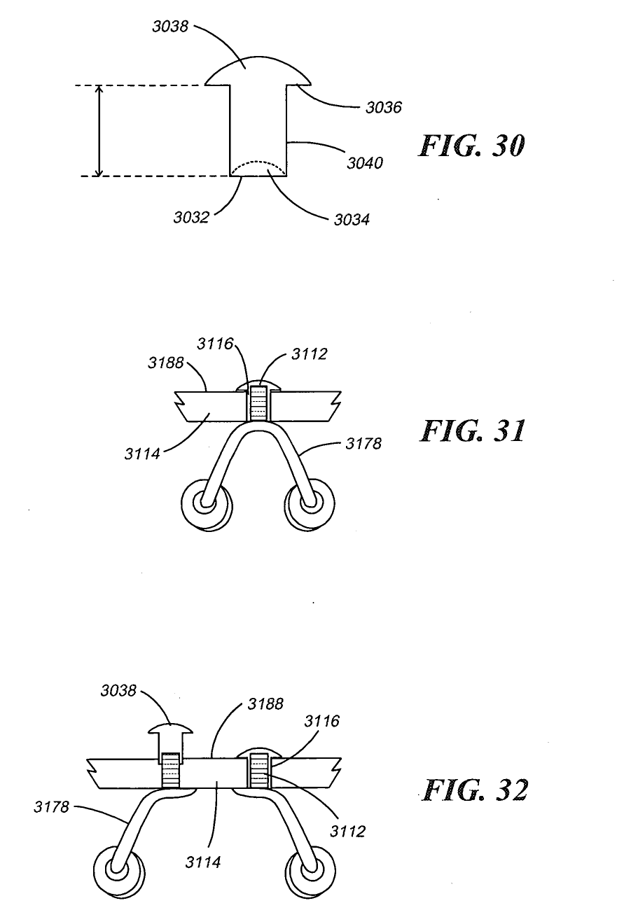

FIG. 30 shows a front perspective view of an alternative embodiment of the captive fastener 3018. The captive fastener 3018 of FIG. 30 is similar to the captive fastener 518 of FIG. 5 except for the placement of the stopping collar. For example, the captive fastener 518 of FIG. 5 includes a stopping collar 538 positioned in between the hollow member 534 and the second end 536 of the fastening member 540. The captive fastener 3018 includes a first end 3032. The first end 3032 comprises a hollow member 3034 with an inner cavity volume that is adapted for receiving an aciculate end 112 of a first component of an eyeglass assembly, as discussed above with respect to FIG. 4 and FIG. 5. The hollow member 434 also includes an outer volume defined to be inserted into a second component of the eyeglass assembly, as discussed above with respect to FIG. 4 and FIG. 5.

The fastening member 3040 also includes a stopping collar 3038 formed at a second end 3036 of the hollow member 3034. The stopping collar 3038 defines an insertable depth d by which the first end of the fastening member 3032 can be inserted into the opening 116 of the second member. The stopping collar 3038 prevents the hollow member 3034 from passing completely through the opening of the second component.

FIG. 31 shows a top planar view of the captive fastener 3018 after being inserted into a second component of an eyeglass assembly for removeably fastening the first component and second component together. FIG. 32 shows another embodiment where two captive fasteners 3038 are separately fastening two nose pad arms 3178 to a nose bridge 3114. The aciculate end 3112 of the first component of the eyeglass assembly, for example, the nose pad arms 3178, is inserted into the corresponding opening 3116 of the second component of the eyeglass assembly, in this example, the second component is a nose bridge 3114. The aciculate end 3112 pass completely through the nose bridge 3114. The captive fastener 3018 is disposed on the aciculate end 3112 by applying a horizontal force to the captive fastener 3018 in a parallel direction with the aciculate ends 112. The horizontal force can be applied, for example, by a tool or by pushing the captive fastener 3018 onto the aciculate end 3112. As the horizontal force is applied, the first end 3032 of the fastening member 3040 captively engages the aciculate end 3112 and becomes inserted into the opening 3116 of the nose bridge 3114. When the first end 3032 reaches its maximum insertable depth d which in this embodiment is the thickness of the nose bridge 3114, the stopping collar 3038 abuts an adjacent surface 3188 of the nose bridge 3114. This results in the first component and the second component being removeably fastened together.

### NON-LIMITING EXAMPLES

Although a specific embodiment of the invention has been disclosed. It will be understood by those having skill in the art that changes can be made to this specific embodiment without departing from the spirit and scope of the invention. The scope of the invention is not to be restricted, therefore, to the specific embodiment, and it is intended that the appended claims cover any and all such applications, modifications, and embodiments within the scope of the present invention.

As required, detailed embodiments of the present invention are disclosed herein; however, it is to be understood that the disclosed embodiments are merely exemplary of the invention, which can be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting; but rather, to provide an understandable description of the invention.

The terms “a” or “an,” as used herein, are defined as “one or more than one.” The term “plurality,” as used herein, is defined as “two or more than two.” The term “another,” as used herein, is defined as “at least a second or more.” The terms “including” and/or “having,” as used herein, are defined as “comprising” (i.e., open language).

The lens in the primary or auxiliary frames made be made of any material including plastic, glass, and a combination thereof. Further the lens includes clear, safety glass, polarized, gray, photo-gray, safety, magnifying, bi-focal, tri-focal, prescription and combinations of these.

What is claimed is:

1. A captive fastener for use with eyeglass assemblies, the captive fastener comprising:
at least one fastening member including:
a first end and a second end, the first end comprising a hollow member with an inner cavity volume adapted for receiving an aciculate end of a first component of an eyeglass assembly, the hollow member with an outer volume defined to be inserted into a second component of the eyeglass assembly having an opening therein, for removeably fastening together the first component with the second component; and
a stopping collar formed around the outer volume of the hollow member between a first end of the fastening member and a second end of the fastening member for defining an insertable depth by the first end of the fastening member into the opening of the second member, whereby the aciculate end of the first component passes completely through the opening of the second member.

2. The captive fastener of claim 1, wherein the stopping collar is formed the second end of the fastening member for defining an insertable depth by the first end of the fastening member into the opening of the second member, whereby the aciculate end of the first component passes completely through the opening of the second member.

3. The captive fastener of claim 1, wherein the first component of the eyeglass assembly comprises one of:
a nose bridge;
a nose pad;
a nose pad arm;
a temple piece;
an extension arm;
a frame; and
an ear stem.

4. The captive fastener of claim 1, wherein the second component of the eyeglass assembly having an opening therein comprises one of:
a lens;
a nose bridge;
a nose pad arm;
a temple piece;
an ear stem; and
a frame.

5. The captive fastener of claim 1, wherein the aciculate end of the first component includes threads.

6. The captive fastener of claim 1, wherein the hollow member of the first end of the fastening member is prevented from passing completely through the opening of the second component by the stopping collar.

7. The captive fastener of claim 1, wherein the second end of the at least one fastening member has at least one magnetic member disposed thereon.

8. The captive fastener of claim 7, wherein the first component is a nose bridge and the second component is one of:
a frame; and
a lens;
wherein the first end of the fastening member removeably fastens together an aciculate end of the nose bridge with the second component so that the magnetic member of the second end of the fastening member is positioned on a side of the second component opposite the nose bridge.

9. The captive fastener of claim 7, wherein the first component is an ear stem and the second component is a temple piece, and wherein the first end of the fastening member removeably fastens together an aciculate end of the ear stem with the temple piece so that the magnetic member of the second end of the fastening member is disposed on a first portion of the second component opposite of a second portion of the second component into which the aciculate end of the ear stem was inserted into the second component.

10. The captive fastener of claim 9, wherein the first component is a temple piece and the second component is one of at:
a frame;
a lens; and
an ear stem, wherein the first end of the fastening member removeably fastens together at least one aciculate end of the temple piece so that the magnetic member of the second end of the fastening member is positioned on a first portion of the second component opposite of a second portion of the second component into which the aciculate end of the temple piece was inserted into the second component.

11. The captive fastener of claim 7, wherein the eyeglass assembly is a set of primary spectacles, and wherein the magnetic member couples a set of auxiliary spectacles to the set of primary spectacles.

12. The captive fastener of claim 7, wherein the eyeglass assembly is a set of auxiliary spectacles, and wherein the magnetic member couples the set of auxiliary spectacles to a set of primary spectacles.

13. The captive fastener of claim 3, wherein the frame is one of:
half-rim;
full-rim;
rim-less; and
partial-rim.

14. The captive fastener of claim 4, wherein the frame is one of:
half-rim;
full-rim;
rim-less; and
partial-rim.

15. The captive fastener of claim 3, wherein the frame is one of:
a primary frame; and
an auxiliary frame for removeably attaching the frame to another frame.

16. Auxiliary spectacles for use in conjunction with primary spectacles, the auxiliary spectacles comprising:
at least one receiving component having at least one opening therein;
at least one insertable component including at least one aciculate end; and
at least one captive fastener comprising:
at least one fastening member including:
a first end and a second end, the first end comprising a hollow member with an inner cavity volume adapted for receiving the aciculate end of the insertable component, the hollow member with an outer volume defined to be inserted into the opening of the receiving component, for removeably fastening together the receiving component with the insertable component; and
a stopping collar formed around the outer volume of the hollow member between the first end of the fastening member and the second end of the fastening member for defining an insertable depth by the first end of the fastening member into the opening of the receiving component.

17. The auxiliary spectacles of claim 16, wherein the at least one receiving component comprises one of:
a frame; and
at least one lens;

18. The auxiliary spectacles of claim 16, wherein the at least one insertable component comprises one of:
a nose bridge;
a pair of hinged extension arms; and
a frame.

19. The auxiliary spectacles of claim 17, wherein the at least one lens is one of:
polarized;
shaded;
colored;
clear;
auto graying; and
at least partially magnified.

20. The auxiliary spectacles of claim 16, wherein the aciculate end of the insertable component includes threads.

21. The auxiliary spectacles of claim 16, wherein the fastening member comprises two fastening members.

22. The auxiliary spectacles of claim 16, wherein the hollow member of the first end of the fastening member is prevented from passing completely through the opening of the receiving component by the stopping collar.

23. The auxiliary spectacles of claim 16, wherein each hinged extension arm of the pair of hinged extension arms includes an outer end with at least one of;
at least one magnetic member; and
a forked member disposed thereon.

24. The auxiliary spectacles of claim 23, wherein the one or more magnetic members of the hinged extension arms magnetically couple the auxiliary spectacles to primary spectacles, the primary spectacles including:
at least a first component and at least as second component removeably fastened together by a primary frame captive fastener, the primary frame captive fastener having at least one magnetic member disposed thereon for magnetically coupling the primary spectacles to the auxiliary spectacles.

25. The auxiliary spectacles of claim 23, wherein the forked member removeably couples the auxiliary spectacles to the primary spectacles, the primary spectacles including:
at least a first component and at least a second component removeably fastened together by a primary frame captive fastener; and
a pair of magnetic sleeves covering at least one of the first component and the second component, wherein the magnetic sleeves are disposed so that a portion of the at least one of the first component and the at least second component is exposed for receiving the forked member thereon; so that the auxiliary spectacles are removeably coupled to the primary spectacles by the forked member.

26. The auxiliary spectacles of claim 18, wherein the pair of hinged extension arms pivotally mounts the auxiliary spectacles on the primary frame so that the auxiliary spectacles can be positioned in a least two positions including:
a first position which is in a vision path of a user; and
a second position which is at least partially outside the vision path of the user.

27. The auxiliary spectacles of claim 24, wherein the one and more magnetic members of the pair of hinged extension arms comprises at least one of:
at least one insertable member; and
at least one magnetic member, wherein the one or more insertable members and the magnetic member are formed to removeably fasten with magnetic member disposed on the captive fasteners of the primary spectacles.
